(19) United States
(12) Patent Application Publication
(10) Pub. No.: US 2026/0023975 A1
(43) Pub. Date: Jan. 22, 2026

(54) HOME: HIGH-ORDER MIXED MOMENT-BASED EMBEDDING FOR REPRESENTATION LEARNING

(71) Applicant: Rensselaer Polytechnic Institute, Troy, NY (US)

(72) Inventors: Ge Wang, Loudonville, NY (US); Chuang Niu, Troy, NY (US)

(73) Assignee: Rensselaer Polytechnic Institute, Troy, NY (US)

(21) Appl. No.: 18/994,694

(22) PCT Filed: Jul. 17, 2023
(86) PCT No.: PCT/US2023/027876

§ 371 Date: Jan. 15, 2025

Related U.S. Application Data
(60) Provisional application No. 63/389,501, filed on Jul. 15, 2022.

(51) Int. Cl. G06N 3/0895; G06F 18/15; G06N 3/0455; G06N 3/084

(52) U.S. Cl. CPC G06N 3/0895; G06F 18/15; G06N 3/0455; G06N 3/084

(57) ABSTRACT

In an embodiment, there is provided a self-supervised representation learning (SSRL) circuitry. The SSRL circuitry includes a normalizer circuitry, and a loss function circuitry. The normalizer circuitry is configured to receive a number. T, batches of embedding features. Each batch includes a number. N, embedding features. The number N corresponds to a number of input samples in a training batch. The number T corresponds to a number of respective transformed batches. Each transformed batch corresponds to a respective transformation of the training batch. The embedding features may be related to the transformed batches. Each embedding feature has a dimension. D. and each embedding feature element corresponds to a respective feature variable. The normalizer circuitry is further configured to normalize each feature variable of a selected batch, using a zero mean and a unit standard deviation of the selected batch. A loss function circuitry is configured to determine a loss function based, at least in part, on a factorizable mixed moment of a plurality of normalized feature variables. The mixed moment is of order K. K is less than or equal to the embedding feature dimension D.

### CROSS REFERENCE TO RELATED APPLICATION(S)

This application claims the benefit of U.S. Provisional Application No. 63/389,501, filed Jul. 15, 2022, which is incorporated by reference as if disclosed herein in its entirety.

### GOVERNMENT LICENSE RIGHTS

This invention was made with government support under award numbers CA237267, and EB031102, both awarded by the National Institutes of Health (NIH). The government has certain rights in the invention.

### FIELD

The present disclosure relates to representation learning, in particular to, high order mixed moment-based embedding for representation learning.

### BACKGROUND

Self-supervised representation learning (SSRL) maps high-dimensional data into a meaningful embedding space, where samples of similar semantic content are close to each other. SSRL has been a core task in machine learning and has experienced relatively rapid progress. Deep neural networks pre-trained on large-scale unlabeled datasets via SSRL have demonstrated desirable characteristics, including relatively strong robustness and generalizability, improving various down-stream tasks when annotations are scarce. Minimizing redundancy among different elements of an embedding in a latent space is useful in representation learning to capture intrinsic informational structures. Existing self-supervised learning methods are configured to minimize a pair-wise covariance matrix to reduce the feature redundancy. Representation features of multiple variables may contain redundancy among more than two feature variables.

### SUMMARY

In some embodiments, there is provided a self-supervised representation learning (SSRL) circuitry. The SSRL circuitry includes a normalizer circuitry, and a loss function circuitry. The normalizer circuitry is configured to receive a number, T, batches of embedding features. Each batch includes a number, N, embedding features. The number N corresponds to a number of input samples in a training batch. The number T corresponds to a number of respective transformed batches. Each transformed batch corresponds to a respective transformation of the training batch. The embedding features may be related to the transformed batches. Each embedding feature has a dimension, D, and each embedding feature element corresponds to a respective feature variable. The normalizer circuitry is further configured to normalize each feature variable of a selected batch, using a zero mean and a unit standard deviation of the selected batch. A loss function circuitry is configured to determine a loss function based, at least in part, on a factorizable mixed moment of a plurality of normalized feature variables. The mixed moment is of order K. K is less than or equal to the embedding feature dimension D.

In some embodiments of the SSRL circuitry, at least one network parameter of an encoder circuitry is adjusted based, at least in part, on the determined loss function, the adjusting configured to reduce a total correlation between a plurality of feature variables.

In some embodiments of the SSRL circuitry, the loss function comprises a transform invariance constraint.

In some embodiments of the SSRL circuitry, the loss function is:

$$L = \frac{1}{D} {\sum }_{d = 1}^{D} \frac{2}{T ( T - 1 )} {\sum }_{i , j = 1 , i \neq j}^{T} {( 1 - {\sum }_{n = 1}^{N} {\hat{z}}_{nd}^{i} {\hat{z}}_{nd}^{i} )}^{2} + λ \frac{1}{T} {\sum }_{i = 1}^{T} \frac{1}{M} {\sum }_{K = 2}^{D} {\sum }_{d 1 , d 2 , … , {d}_{K}}^{} {( \frac{1}{N} {\sum }_{n = 1}^{N} {{\prod }^{K}}_{k = 1} {\hat{z}}_{{nd}_{k}}^{i} )}^{2} .$$

In some embodiments of the SSRL circuitry, each feature variable is normalized as:

$${\hat{z}}_{nd}^{t} = \frac{{z}_{and}^{t} - \frac{1}{N} {\sum }_{n = 1}^{N} {z}_{nd}^{t}}{\sqrt{{\sum }_{n = 1}^{N} {( {z}_{nd}^{t} - \frac{1}{N} {\sum }_{n = 1}^{N} {z}_{nd}^{t} )}^{2}}} .$$

In some embodiments of the SSRL circuitry, K is two or three.

In some embodiments of the SSRL circuitry, each transformation is selected from the group comprising random cropping, horizontal flip, color jittering, grayscale, Gaussian blur, and solarization.

In some embodiments, there is provided a method for self-supervised representation learning (SSRL) circuitry. The method includes receiving, by a normalizer circuitry, a number, T, batches of embedding features. Each batch includes a number, N, embedding features. The number N corresponds to a number of input samples in a training batch. The number T corresponds to a number of respective transformed batches. Each transformed batch corresponds to a respective transformation of the training batch. The embedding features are related to the transformed batches. Each embedding feature has a dimension, D, and each embedding feature element corresponding to a respective feature variable. The method further includes normalizing, by the normalizer circuitry, each feature variable of a selected batch, using a zero mean and a unit standard deviation of the selected batch. The method further includes determining, by a loss function circuitry, a loss function based, at least in part, on a factorizable mixed moment of a plurality of normalized feature variables. The mixed moment is of order K. K is less than or equal to the embedding feature dimension D.

In some embodiments of the method, at least one network parameter of an artificial neural network (ANN) is adjusted based, at least in part, on the determined loss function. The adjusting is configured to reduce a total correlation between a plurality of feature variables.

In some embodiments, the method further includes receiving, by a transform circuitry, input data including a training batch containing the number, N, training samples. The method further includes transforming, by the transform circuitry, the training batch into the number, T, respective transformed batches. Each transformed batch contains the number N transformed samples. The method further includes mapping, by an encoder circuitry, each batch of transformed samples into a respective set of representation features. The method further includes mapping, by a projector circuitry, each set of representation features into a respective batch of embedding features. At least one network parameter of the encoder circuitry is adjusted based, at least in part, on the determined loss function.

In some embodiments of the method, the loss function includes a transform invariance constraint.

In some embodiments of the method, a loss function is:

$$L = \frac{1}{D} {\sum }_{d = 1}^{D} \frac{2}{T ( T - 1 )} {\sum }_{i , j = 1 , i \neq j}^{T} {( 1 - {\sum }_{n = 1}^{N} {\hat{z}}_{nd}^{i} {\hat{z}}_{nd}^{j} )}^{2} + λ \frac{1}{T} {\sum }_{t = 1}^{T} \frac{1}{M} {\sum }_{K = 2}^{D} {\sum }_{d 1 , d 2 , … , {d}_{K}} {( \frac{1}{N} {\sum }_{n = 1}^{N} {{\prod }_{k = 1}}^{K} {\hat{z}}_{{nd}_{k}}^{i} )}^{2} .$$

In some embodiments of the method, each feature variable is normalized as:

$${\hat{z}}_{nd}^{t} = \frac{{z}_{nd}^{t} - \frac{1}{N} {\sum }_{n = 1}^{N} {z}_{nd}^{t}}{\sqrt{{\sum }_{n = 1}^{N} {( {z}_{nd}^{t} - \frac{1}{N} {\sum }_{n = 1}^{N} {z}_{nd}^{t} )}^{2}}} .$$

In an embodiment, there is provided a self-supervised representation learning (SSRL) system. The SSRL system includes a transform circuitry, an artificial neural network (ANN), and an SSRL circuitry. The transform circuitry is configured to receive input data. The input data includes a training batch containing a number, N, training samples. The transform circuitry configured to transform the training batch into a number, T, respective transformed batches. Each transformed batch contains the number N transformed samples. The ANN is configured to determine a respective batch of embedding features for each batch of transformed samples. The SSRL circuitry includes a normalizer circuitry, and a loss function circuitry. The normalizer circuitry is configured to receive the number, T, batches of embedding features. Each batch includes the number, N, embedding features. The number T corresponds to a number of respective transformed batches. Each transformed batch corresponds to a respective transformation of the training batch. The embedding features are related to the transformed batches. Each embedding feature has a dimension, D, and each embedding feature element corresponds to a respective feature variable. The normalizer circuitry is further configured to normalize each feature variable of a selected batch, using a zero mean and a unit standard deviation of the selected batch. The loss function circuitry is configured to determine a loss function based, at least in part, on a factorizable mixed moment of a plurality of normalized feature variables. The mixed moment of order K, K less than or equal to the embedding feature dimension D.

In some embodiments of the SSRL system, at least one network parameter of the ANN is adjusted based, at least in part, on the determined loss function. The adjusting is configured to reduce a total correlation between a plurality of feature variables.

In some embodiments of the SSRL system, the ANN includes an encoder circuitry, and a projector circuitry. The encoder circuitry is configured to map each batch of transformed samples into a respective set of representation features. The projector circuitry is configured to map each set of representation features into a respective batch of embedding features. At least one network parameter of the encoder circuitry is adjusted based, at least in part, on the determined loss function.

In some embodiments of the SSRL system, the loss function includes a transform invariance constraint.

In some embodiments of the SSRL system, the loss function is:

$$L = \frac{1}{D} {\sum }_{d = 1}^{D} \frac{2}{T ( T - 1 )} {\sum }_{i , j = 1 , i \neq j}^{T} {( 1 - {\sum }_{n = 1}^{N} {\hat{z}}_{nd}^{i} {\hat{z}}_{nd}^{j} )}^{2} + λ \frac{1}{T} {\sum }_{t = 1}^{T} \frac{1}{M} {\sum }_{K = 2}^{D} {\sum }_{d 1 , d 2 , … , {d}_{K}} {( \frac{1}{N} {\sum }_{n = 1}^{N} {{\prod }_{k = 1}}^{K} {\hat{z}}_{{nd}_{k}}^{i} )}^{2} .$$

In some embodiments of the SSRL system, each feature variable is normalized as:

$${\hat{z}}_{nd}^{t} = \frac{{z}_{nd}^{t} - \frac{1}{N} {\sum }_{n = 1}^{N} {z}_{nd}^{t}}{\sqrt{{\sum }_{n = 1}^{N} {( {z}_{nd}^{t} - \frac{1}{N} {\sum }_{n = 1}^{N} {z}_{nd}^{t} )}^{2}}} .$$

In some embodiments, there is provided a computer readable storage device. The device has stored thereon instructions that when executed by one or more processors result in the following operations including: any embodiment of the method.

### BRIEF DESCRIPTION OF DRAWINGS

The drawings show embodiments of the disclosed subject matter for the purpose of illustrating features and advantages of the disclosed subject matter. However, it should be understood that the present application is not limited to the precise arrangements and instrumentalities shown in the drawings, wherein:

FIG. 1 illustrates a functional block diagram of a system that includes a self-supervised representation learning (SSRL) system, according to several embodiments of the present disclosure;

FIG. 2 is a sketch illustrating a high order mixed moment-embedding (HOME) framework for self-supervised representation learning, according to the present disclosure;

FIG. 3 is a sketch of four example model variants illustrating two and three order moments, according to several embodiments of the present disclosure; and

FIG. 4 is a flowchart of operations for self-supervised representation learning, according to various embodiments of the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure relates to representation learning, in particular to, high order mixed moment-based embedding (“HOME”) for representation learning. An apparatus, system, and/or method, according to the present disclosure, is configured to reduce redundancy between any sets of feature variables. It may be appreciated that multivariate mutual information is minimized if, and only if, the corresponding multiple variables are mutually independent. Mutual independence implies that a mixed moment of multiple (i.e., plurality) of feature variables can be factorized into a multiplication of their individual moments. If feature variables are mutually independent, then for every K variables, with K less than or equal to D, a dimension of embedding features, mixed moments among K variables can be factorized to a multiplication of their individual expectations. The expected values may be estimated as means of observed samples. In an embodiment, a HOME loss function, utilized for self-supervised representation learning (SSRL), is configured to constrain empirical mixed moments to be factorizable.

It may be appreciated that representation learning that maps relatively high-dimensional data into semantic features (i.e., embedding features) is a fundamental task in computer vision, machine learning, and artificial intelligence. For example, self-supervised representation learning (SSRL) on relatively large-scale unlabeled datasets has been applied to various applications, such as object detection and segmentation, deep clustering, medical image analysis, etc. To learn meaningful representations without annotations, various pretext tasks have been heuristically designed for SSRL, such as denoising auto-encoders, context auto-encoders, cross-channel auto-encoders or colorization, masked auto-encoders, rotation, patch ordering, clustering, and instance discrimination. Semantic invariance to predefined transformations of a same instance has been used as a pretext task in various SSRL methods due to its effectiveness and efficiency. To avoid trivial solutions (e.g., the features of all samples correspond to a constant vector), these methods may use various special techniques, such as large batches or a memory bank, momentum updating, asymmetry network architecture with additional predictor head and stop gradients. In another direction, W-MSE (Whitening Mean Squared Error (loss function)), Barlow Twins, and VICReg (Variance-Invariance-Covariance Regularization) are configured to drive covariance matrices towards the identity matrix to minimize the pairwise correlation, explicitly avoiding trivial solutions without requiring an asymmetric constraint on network architectures nor on a training process.

Generally, the present disclosure relates to a principled approach for self-learning, based on general characteristics of expected embedding features. It may be appreciated that a desired property is that semantically similar samples have similar embedding features. This can be approximately achieved by a pretext task of transform invariance. In transform invariance, different transformations of a same instance are configured to have a same embedding features. The transformation may be randomly performed according to a predefined transform distribution, including, but not limited to, random cropping, horizontal flip, color jittering, grayscale, Gaussian blur, and solarization (assuming that these transformations will not affect the semantic meanings of an original instance).

Embedding features correspond to feature variables, as described herein. Reducing or minimizing redundancy among feature variables is configured to reduce or minimize the mutual information between any sets of variables. With minimum redundancy as a constraint, learned features may be enriched, concentrated, and decomposed to be informative. It may be appreciated that while existing approaches may include pairwise correlation by enforcing the off-diagonal elements of a covariance matrix to be zero, minimum redundancy among multiple (i.e., a plurality, e.g., more than two) feature variables may not be achieved using pairwise correlation.

Theoretically, multivariate mutual information or total correlation is minimum, if and only if, a set of multiple (i.e., a plurality of) variables are mutually independent. It may be appreciated that pairwise independence may not ensure mutual independence. Mutual independence means that a mixed moment of a plurality of feature variables can be factorized into a multiplication (i.e., multiplicative product) of their individual moments. Based, at least in part, on this observation, a general framework for High-Order Mixed-Moment-based Embedding (HOME), according to the present disclosure, is configured to empower self-supervised representation learning.

A three-order SSRL circuitry corresponding to the HOME framework was instantiated and evaluated. Experimental results, using image data as a nonlimiting example, e.g., on CIFAR-10 (Canadian Institute of Advanced Research collection of images data set, including 10 classes), in a linear classification evaluation on fixed representation features illustrated improved performance relative to a two-order baseline (e.g., Barlow Twins on the CIFAR-10 data set).

Generally, in self-supervised representation learning, an input data set (i.e., system data) is provided to an SSRL system that includes an artificial neural network (ANN), as described herein. A goal of an embodiment, according to the present disclosure, is to train the neural network to extract meaningful features on an unlabeled dataset in a self-supervised learning manner. The input data set includes one or more batches of training samples. In each training iteration, a batch of training samples {xₙ}ₙ₌₁^{N} may be transformed into T distorted versions {{xₙ^{t}}ₙ₌₁^{N}}ₜ₌₁^{T}. Distortions may include, but are not limited to, random cropping, horizontal flip, color jittering, grayscale, Gaussian blur, and solarization. In one nonlimiting example, T may be set to 2. However, this disclosure is not limited in this regard. It may be appreciated that a smaller T may correspond to lesser memory and computation costs. Relatively better results may be achieved using more than two transformations, with a corresponding increase in memory and computation costs. The transformed images may then be forwarded to an artificial neural network (ANN).

In one nonlimiting example, the ANN may include an encoder configured to map a batch of transformed samples to a set of representation features and a projector configured to map the representation features to a batch of embedding features. In other words, embedding feature

$${z}_{n}^{t} = G ( F ( {x}_{n}^{t} ; {θ}_{F} ) ; {θ}_{G} ) ∈ {R}^{D} ,$$

where F(·; θ_{F}) denotes the encoder function with a vector of parameters θ_{F}, G(·; θ_{G}) denotes the projector function with another vector of parameters θ_{G}, and D is the dimension of embedding features. In an embodiment, a generally expected property of meaningful embedding features may be learned, without special constraints on a network architecture or the optimization process.

By way of theoretical background, and considering high order mixed moment-based embedding, a property of an SSRL circuitry may facilitate generating training data that configures an ANN to produce relatively meaningful embedding features. Properties may include, but are not limited to, invariance to random transformations and minimum total correlation among all feature variables. The invariance is configured to drive semantically similar samples close to each other in the embedding space, a pretext task in various SSRL methods. A total correlation among all feature variables may be reduced or minimized so that informative features can be learned into a compact vector, similar to coordinates of a point in a Cartesian coordinate system The total correlation of random variables z₁, z₂, . . . , z_{D} may be defined as:

$$I ( {Z}_{1} , {Z}_{2} , … , {Z}_{D} ) = {\int }_{{z}_{1}} {\int }_{{z}_{2}} … {\int }_{{z}_{D}} P ( {z}_{1} , {z}_{2} , … , {z}_{D} ) log \frac{P ( {z}_{1} , {z}_{2} , … , {z}_{D} )}{P ( {z}_{1} ) P ( {z}_{2} ) … P ( {z}_{D} )} {dz}_{1} {dz}_{2} … {dz}_{D} . \qquad ( 1 )$$

I(Z₁, Z₂, . . . , Z_{D}) is configured to measure an amount of information shared among multiple random variables.

It may be appreciated that I(Z₁, Z₂, . . . , Z_{D}) is minimized if and only if a corresponding joint probability density distribution (i.e., probability density function (PDF)) can be factorized into corresponding individual PDFs; i.e., P(z₁, z₂, . . . , z_{D})=P(z₁)P(z₂) . . . . P(z_{D}), meaning that all variables are mutually independent. It may be appreciated that pairwise independence may not ensure the mutual independence of an entire set of random variables. In other words, even if the mutual information between every two variables is zero, the multivariate mutual information may still have not been minimized. It may be appreciated that to systematically reduce the informational redundancy among all feature variables, the total correlation should be minimized. It may be further appreciated that it is generally difficult to estimate the probability distribution of continuous variables so that I(Z₁, Z₂, . . . , Z_{D}) may not be directly minimized. It may be appreciated that if all variables are mutually independent, then for every K variables, K≤D, and for any K indices 1≤d₁≤ . . . ≤dₖ≤D:

$$\begin{matrix}E [ {\sum }_{k = 1}^{K} {Z}_{{d}_{k}} ] = {\int }_{{z}_{{d}_{1}}} {\int }_{{z}_{{d}_{2}}} … {\int }_{{z}_{{d}_{k}}} P ( {z}_{{d}_{1}} , {z}_{{d}_{2}} , … , {z}_{{d}_{k}} ) {dz}_{{d}_{1}} {dz}_{{d}_{2}} {dz}_{{d}_{k}} \\ = {\int }_{{z}_{{d}_{1}}} P ( \text{?} ) {dz}_{{d}_{1}} {\int }_{{z}_{{d}_{2}}} P ( {z}_{{d}_{2}} ) {dz}_{{d}_{2}} … {\int }_{{z}_{{d}_{k}}} P ( {z}_{{d}_{k}} ) {dz}_{{d}_{k}} \\ = {\prod }_{k = 1}^{K} E [ {Z}_{{d}_{k}} ] ,\end{matrix} \qquad ( 2 )$$

$$\text{?} \text{indicates text missing or illegible when filed}$$

which means that the mixed moments.

$$E [ {\prod }_{i = 1}^{K} {Z}_{{d}_{k}} ] ,$$

among K variables can be factorized to the multiplication of their individual expectations (i.e., expected values). The expected values can be estimated as the means of observed samples. When K=2, the general mixed moment is degraded to the pairwise correlation. If and only if the joint distribution P(z_{d}_{₁}, z_{d}_{₂}, . . . , z_{d}_{ₖ}) is a multivariate normal distribution, the pairwise zero correlation is equivalent to the mutual independence or minimum total correlation. The joint normal distribution among all features variables generally cannot be ensured in practice. Hence, the necessary conditions of factorizable mixed moments in Eq. (2) should be satisfied to drive the total correlation towards zero.

Based on the above analysis, a HOME loss may be written as:

$$L = \frac{1}{D} {\sum }_{d = 1}^{D} \frac{2}{T ( T - 1 )} \text{?} {( 1 - {\sum }_{n = 1}^{N} \text{?} )}^{2} + λ \frac{1}{T} \text{?} \frac{1}{M} \text{?} {( \frac{1}{N} \text{?} {\prod }_{k = 1}^{K} \text{?} )}^{2} , \qquad ( 3 )$$

$$\text{?} \text{indicates text missing or illegible when filed}$$

where all feature variables za are normalized with a zero mean and a unit standard deviation, denoted by

$${\hat{z}}_{d}^{t}$$

as:

$${\hat{z}}_{nd}^{t} = \frac{{z}_{nd}^{t} - \frac{1}{N} {\sum }_{n = 1}^{N} {z}_{nd}^{t}}{\sqrt{{\sum }_{n = 1}^{N} {( {z}_{nd}^{t} - \frac{1}{N} {\sum }_{n = 1}^{N} {z}_{nd}^{t} )}^{2}}} . \qquad ( 4 )$$

The first term in Eq. (3) is configured to enforce the embedding features from different transformation of a same instance to the be the same, which is a multi-view transformation. The second term illustrates an embodiment of the present disclosure configured to constrain the empirical mixed moments to be subject to Eq. (2); i.e.,

$$E [ {\prod }_{k = 1}^{K} {\hat{Z}}_{{d}_{k}} ] = {\prod }_{k = 1}^{K} E [ {\hat{Z}}_{{d}_{k}} ] = 0 ,$$

as ∀dₖ, E[\hat{Z}_{d}_{ₖ}]=0 after normalization in Eq. (4), and

$$M = {\sum }_{K = 2}^{D} \frac{D !}{( D - K ) ! K !}$$

is the total number of combinations for all orders of moments, where K denotes the order of moments. In one nonlimiting example, λ=1.

Thus, the HOME loss function (Eq. (2)), utilized for self-supervised representation learning (SSRL), is configured to constrain empirical mixed moments to be factorizable.

In an embodiment, there is provided a self-supervised representation learning (SSRL) circuitry. The SSRL circuitry includes a normalizer circuitry, and a loss function circuitry. The normalizer circuitry is configured to receive a number, T, batches of embedding features. Each batch includes a number, N, embedding features. The number N corresponds to a number of input samples in a training batch. The number T corresponds to a number of respective transformed batches. Each transformed batch corresponds to a respective transformation of the training batch. The embedding features may be related to the transformed batches. Each embedding feature has a dimension, D, and each embedding feature element corresponds to a respective feature variable. The normalizer circuitry is further configured to normalize each feature variable of a selected batch, using a zero mean and a unit standard deviation of the selected batch. A loss function circuitry is configured to determine a loss function based, at least in part, on a factorizable mixed moment of a plurality of normalized feature variables. The mixed moment is of order K. K is less than or equal to the embedding feature dimension D.

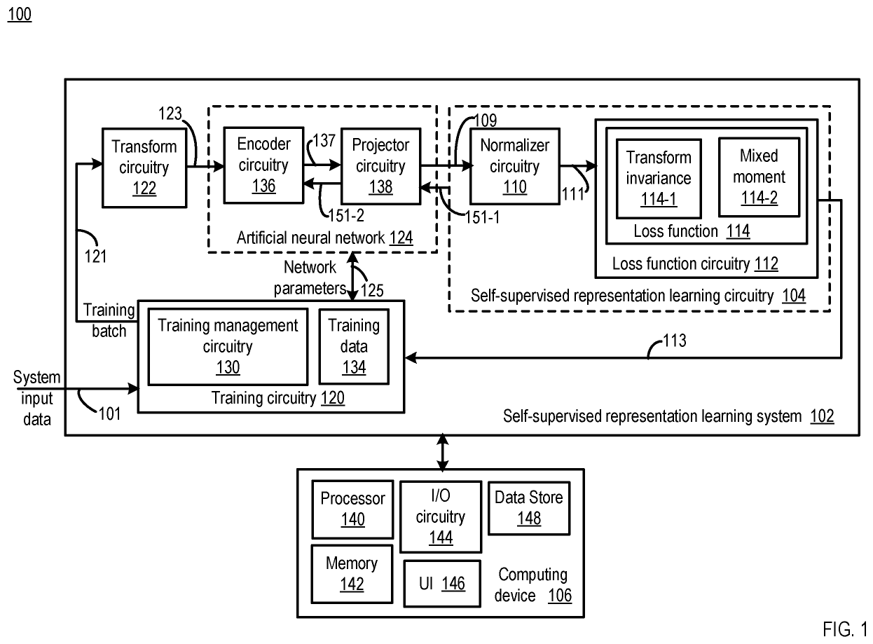

FIG. 1 illustrates a functional block diagram 100 of a system that includes a self-supervised representation learning system (SSRL) 102, according to several embodiments of the present disclosure. System 100 may further include a computing device 106. SSRL system 102 includes an SSRL circuitry 104, a training circuitry 120, a transform circuitry 122, and an artificial neural network (ANN) 124. The training circuitry 120 includes training management circuitry 130, and may include training data 134.

SSRL circuitry 104 includes a normalizer circuitry 110, and a loss function circuitry 112. The loss function circuitry 112 may include loss function 114 that includes one or more terms. A first loss term 114-1 may correspond to a transform-invariance constraint, as described herein. A second loss term 114-2 corresponds to a mixed moment constraint, as described herein.

In one nonlimiting example, the ANN 124 may include and encoder circuitry 136, and a projector circuitry 138. However, this disclosure is not limited in this regard. Other ANN architectures may be implemented consistent with the present disclosure. Continuing with this example, it may be appreciated that operations of SSRL system 102 may be configured to train encoder circuitry 136, and the trained encoder circuitry 136 may then be applied to actual data.

Computing device 106 may include, but is not limited to, a computing system (e.g., a server, a workstation computer, a desktop computer, a laptop computer, a tablet computer, an ultraportable computer, an ultramobile computer, a netbook computer and/or a subnotebook computer, etc.), and/or a smart phone. Computing device 106 includes a processor 140, a memory 142, input/output (I/O) circuitry 144, a user interface (UI) 146, and data store 148.

Processor 140 is configured to perform operations of SSRL system 102, including, for example, SSRL circuitry 104, training circuitry 120, transform circuitry 122, and/or ANN 124. Memory 142 may be configured to store data associated with SSRL circuitry 104, and/or training circuitry 120. I/O circuitry 144 may be configured to provide wired and/or wireless communication functionality for SSRL system 102. For example, I/O circuitry 144 may be configured to receive system input data 101 (including, e.g., training data 134). UI 146 may include a user input device (e.g., keyboard, mouse, microphone, touch sensitive display, etc.) and/or a user output device, e.g., a display. Data store 148 may be configured to store one or more of system input data 101, training data 134, one or more training batches 121, network parameters 125, and/or other data associated with SSRL circuitry 104, transform circuitry 122, artificial neural network 124, and/or training circuitry 120. Other data may include, for example, function parameters related to loss function(s) 114 (e.g., related to transform invariance 114-1, and/or mixed moment 114-2), training constraints (e.g., hyper parameters, including, but not limited to, number of epochs, batch size, projector depth, feature dimension, convergence criteria, etc.), etc.

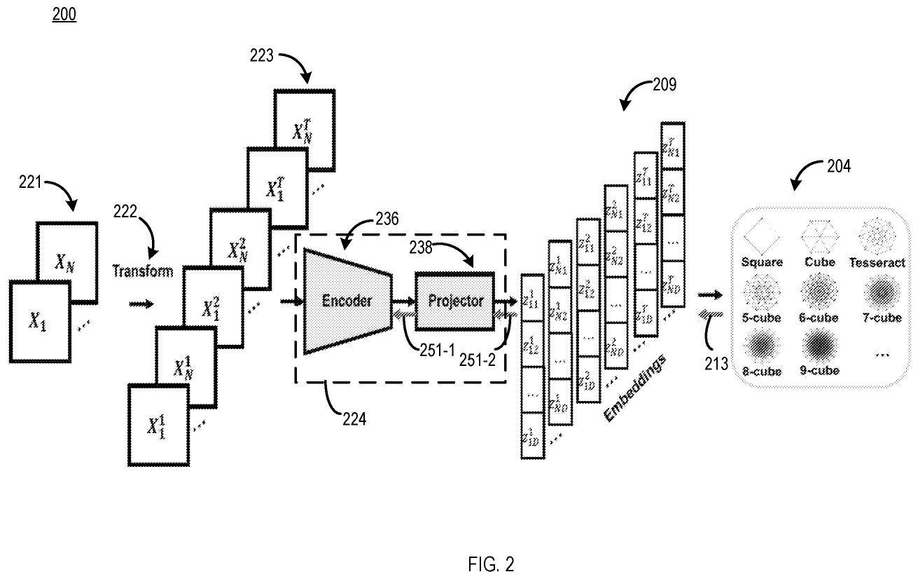

The operation of SSRL system 102 may be best understood when considered in combination with FIG. 2. In operation, SSRL system 102 is configured to receive system input data 101. The system input data 101 may include one or more input data sets. Each input data set may correspond to a batch of training data, e.g., training batch 121. The system input data 101 may be received by training circuitry 120, e.g., training management circuitry 130. In some embodiments, training management circuitry 130 may be configured to manage training data generation operations including, e.g., receiving system input data 101, storing training data sets as training data 134, providing a selected batch of training data (i.e., training batch 121) to transform circuitry 122, receiving a loss function value 113 from SSRP circuitry 104, e.g., loss function circuitry 112, and/or adjusting one or more network parameters 125, related to ANN 124, to reduce or minimize the loss function 114. However, this disclosure is not limited in this regard.

The transform circuitry 122 is configured to receive input data, i.e., the training batch 121. The training batch 121 is configured to contain a number, N, training samples, as described herein. The transform circuitry 122 is further configured to transform the training batch 121 into a number, T, respective transformed batches 123. Each transformed batch is configured to contain the number N transformed samples. Transformations may include, but are not limited to, random cropping, horizontal flip, color jittering, grayscale, Gaussian blur, solarization, etc. The number T transformed batches 123 may then be provided to the ANN 124.

The ANN 124 is configured to receive the T transformed batches 123, and to determine a respective batch of embedding features for each batch of transformed samples. In other words, the ANN is configured to determine the number T batches of embedding features 109. The embedding features 109 may then be provided to the SSRL circuitry 104.

In one nonlimiting example, the ANN 124 may include an encoder circuitry 136 and a projector circuitry 138, coupled in series. The encoder circuitry 136 is configured to map each batch of transformed samples into a respective set of representation features. The number T sets of representation features 137 may then be provided to the projector circuitry 138. The projector circuitry 138 is configured to map each set of representation features into a respective batch of embedding features. The number T batches of embedding features 109 may then be provided to the SSRL circuitry 104.

The SSRL circuitry 104, e.g., normalizer circuitry 110, is configured to receive the number T batches of embedding features 109. Each batch of embedding features includes the number, N, embedding features. The number T corresponds to a number of respective transformed batches. Each transformed batch corresponds to a respective transformation of the training batch 121. The embedding features may be related to the transformed batches 123. Each embedding feature has a dimension, D. Each embedding feature element corresponds to a respective feature variable, as described herein. The normalizer circuitry 110 is further configured to normalize each feature variable of a selected batch, using a zero mean and a unit standard deviation of the selected batch. For example, the normalizer circuitry 110 may be configured to normalize the feature variables of the selected batch based, at least in part, on Eq. (4), as described herein.

The normalized feature variables 111 may then be provided to the loss function circuitry 112. The loss function circuitry 112 is configured to determine a loss function 114. The loss function 114 may include a transform invariance term 114-1 corresponding to a transform invariance constraint, as described herein. The loss function 114-2 includes a mixed moment term 114-2 corresponding to a mixed moment constraint, as described herein. The loss function circuitry may be configured to determine (e.g., evaluate) the loss function 114 based, at least in part, on a factorizable mixed moment of a plurality of normalized feature variables, to yield the loss function value 113. The mixed moment is of order K. K may be less than or equal to the embedding feature dimension D. In one nonlimiting example, the loss function circuitry 112 may be configured to determine the loss function 114 based, at least in part, on Eq. (3), as described herein.

The loss function value 113 may then be provided to, e.g., training circuitry 120, and/or ANN 124. It may be appreciated that, during training there may be a backward gradient flow path that includes a first portion 151-1 from SSRL 104 to ANN 124, and a second portion 151-2, within ANN 124, from projector circuitry 138 to encoder circuitry 136. The backward gradient flow may thus facilitate training ANN 124, as described herein. The trained ANN 124 may then be applied to a selected downstream task.

Thus, an SSRL system 102 with high order mixed moment embedding, according to the present disclosure, may be configured to train an ANN 124, using self-supervised representation learning. The associated loss function may be determined based, at least in part, on a factorizable mixed moment constraint. At least one network parameter may be adjusted based, at least in part, on a determined loss function value. The adjusting is configured to reduce a total correlation between a plurality of feature variables, as described herein.

FIG. 2 is a sketch 200 illustrating a HOME framework for self-supervised representation learning, according to the present disclosure. Sketch 200 is configured to illustrate forward data flow, generation of embedding features (including feature variables) from a training batch, feature variable input to an SSRL circuitry, and backward gradient flow. Sketch 200 corresponds to SSRL system 102 of FIG. 1.

Sketch 200 includes a training batch 221, a transform 222, a set 223 of transformed training batches, one example artificial neural network (ANN) 224, a set 209 of embedding features, and an example SSRL circuitry graphic 204 that includes hypercubes configured to illustrate relatively high-order constraints among a plurality of features variables related to a mixed moment-based loss function.

The training batch 221 includes N input samples, X₁, . . . , X_{N}. A type of input samples may include, but is not limited to, image data, text, and speech data. The set 223 of transformed training batches includes a number, T, transformed batches

$${X}_{1}^{1} , … , {X}_{N}^{1} ; {X}_{1}^{2} , … , {X}_{N}^{2} ; … ; {X}_{1}^{T} , … , {X}_{N}^{T} .$$

Each superscript corresponds to a respective transformed batch of the set of T transformed batches, and each subscript corresponds to a respective input sample of the training batch 221. The set 209 of embedding features includes the number T batches of embedding features, each batch includes the number N embedding features, and each embedding feature has a dimension, D, i.e., each embedding feature contains D feature elements. Thus, the set 209 of embedding features corresponds to

$${z}_{11}^{1} , … , {z}_{1 D}^{1} ; … ; {z}_{N 1}^{1} , … , {z}_{ND}^{1} ; {z}_{11}^{2} , … ; {z}_{1 D}^{2} ; … ; {z}_{N 1}^{2} , … , {z}_{ND}^{2} ; … ; {z}_{11}^{T} , … , {z}_{1 D}^{T} ; … ; {z}_{N 1}^{T} , … , {z}_{ND}^{T} .$$

Each embedding feature element, z_{nd}^{t}, corresponds to a respective feature variable.

The transform 222 is configured to receive the training batch 221, transform the training batch to the set 223 of transformed training batches. The ANN 224 is configured to receive the set 223 of transformed training batches, and to provide the set 209 of embedding features to the SSRL circuitry 204. In one nonlimiting example, ANN 224 includes an encoder 236 and a projector 238. However, this disclosure is not limited in this regard. The ANN 224, e.g., the encoder 236, is configured to receive the set 223 of transformed training batches, and to map each batch of transformed samples to a respective set of representation features, as described herein. The ANN 224, e.g., the projector 238, is configured to map each set of representation features into a respective batch of embedding features, as described herein. The set 209 of embedding features may then be provided to the example SSRL circuitry 204. The example SSRL circuitry 204 may be configured to normalize the embedding features, and evaluate a loss function, as described herein. At least one network parameter of ANN 124 may then be adjusted based, at least in part, on the loss function. A backward gradient flow is illustrated from the example SSRL circuitry 204, to the decoder 236 by arrows 213, 251-1, 251-2.

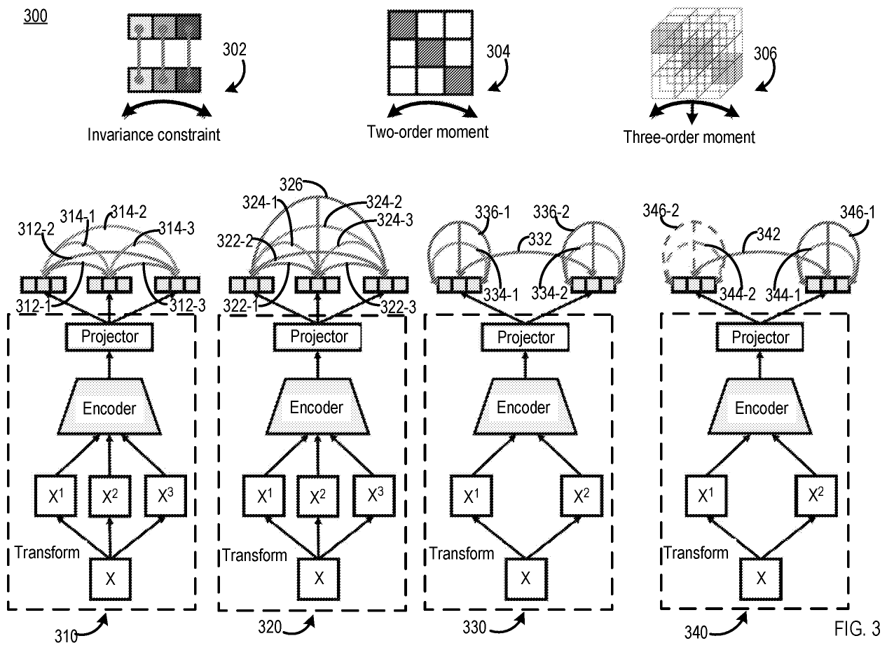

FIG. 3 is a sketch 300 of four example 310, 320, 330, 340 model variants illustrating two and three order moments, according to several embodiments of the present disclosure. Sketch 300 includes graphics illustrating an invariance constraint 302, a two-order moment 304 and a three-order moment 306. The two-order moment 304 graphic is configured as a square, partitioned into nine equal, small squares arranged in a grid. The two-order moment 304 graphic includes three shaded squares on a diagonal, corresponding to elements that are configured to be ignored when determining a corresponding loss function, as described herein. Similarly, the three-order moment 306 graphic is configured as a cube, partitioned into twenty-seven equal, small cubes arranged in a three-dimensional grid. The three-order moment 306 graphic includes three shaded cubes on a diagonal, corresponding to elements that are configured to be ignored when determining a corresponding loss function, as described herein.

Based on a general HOME framework for SSRL, a three-order HOME self-supervised learning method was instantiated, i.e., K∈{2, 3}. To evaluate the effect of our high-order constraint, different variants of two- and three-order HOME were built and evaluated.

A first model variant 310 corresponds to HOME-T3-O2-Cross. The first model variant 310 thus corresponds to a two-order HOME SSRL circuitry, and includes three transformations and a cross-covariance constraint. Three cross-covariance matrices between each two transformations were determined. Graphically, the first model variant includes three two-transformation invariance constraints 312-1, 312-2, 312-3, and three two-order moments 314-1, 314-2, 314-3, with a respective two-order moment for each two-transformation sets of the three transformations.

A second model variant 320 corresponds to HOME-T3-O3-Cross. The second model variant thus corresponds to a three-order HOME SSRL circuitry, and includes three transformations and a cross-mixed moment constraint. Three cross-covariance matrices between each two transformations, and a three-order cross-mixed-moment tensor were determined. Graphically, similar to the first model variant 310, the second model variant 320 includes three two-transformation invariance constraints 322-1, 322-2, 322-3, and three two-order moments 324-1, 324-2, 324-3, with a respective two-order moment for each two-transformation sets of the three transformations. The second model variant 320 further includes the three-order cross-mixed moment.

A third model variant 330 corresponds to HOME-T2-O3-Self-All. The third model variant 330 thus corresponds to a three-order HOME SSRL circuitry, and includes two transformations and self-mixed-moments. Two self-covariance matrices between the two transformations were determined. Graphically, the third model variant includes one two-transformation invariance constraint 332, two two-order moments 334-1, 334-2, and two three-order moments 336-1, 336-2, with two self-covariance matrices and two three-order cross-mixed-moment tensors separately imposed on the two transformations.

A fourth model variant 340 corresponds to HOME-T2-O3-Self-One. The fourth model variant 340 thus corresponds to a three-order HOME SSRL circuitry, and includes two transformations and self-mixed-moments. Two self-covariance matrices between the two transformations were determined. Graphically, the fourth model variant 340 includes one two-transformation invariance constraint 342, two two-order moments 344-1, 344-2, and two three-order moments 346-1, 346-2, where one self-covariance matrix and one three-order self-mixed-moment tensor were imposed on one of the two transformations randomly. A first two-order moment 344-1, and a first three-order moment 346-1 were implemented. For a second two-order moment 344-2, and a second three-order moment 346-2, the corresponding transformation may be not constrained with self-mixed-moments.

In one nonlimiting example, the CIFAR-10 dataset was used to evaluate the example 310, 320, 330, 340 model variants. The ResNet18 (i.e., convolutional neural network (CNN) that is 18 layers deep) was used as the feature encoder and the three-layer MLP (multi-layer perceptron) with the dimension 1024 for each layer was used as the projector, corresponding to an embedding feature dimension D=1024. However, this disclosure is not limited in this regard. An SGD (Stochastic Gradient Descent) optimizer was used with a momentum 0.9 and a weight decay rate 0.0005. A cosine decay schedule from 0 was unimplemented with 10 warm-up epochs towards a final value 0.002. A base learning rate was set to 0.5. A batch size was set to 512. All models were optimized with 800 epochs on a single Tesla V100 GPU. It may be appreciated that the above-described implementation details correspond to one nonlimiting example and are provided for illustration and not limitation.

### Experimental Data

Experiments were performed on the data set CIFAR-10. During training, all models were optimized with an SGD optimizer, batch size was 512, and 800 training epochs were performed. In one nonlimiting example, linear probing was used to evaluate the representation learning performance of different methods. In other words, after the self-supervised training, a linear classifier was stacked onto the encoder network with the frozen parameters while the projector was disregarded. Without using any special constraints, such as asymmetric network structures, momentum updating, memory bank, stop gradient, etc., a HOME SSRL circuitry, according to the present disclosure achieved competitive results on the CIFAR-10 dataset. HOME-T3-O2-Cross achieved a Top-1 of 87.3 and a Top-5 of 99.5. HOME-T3-O3-Cross achieved a Top-1 of 91.1 and a Top-5 of 99.7. HOME-T2-O3-Self-All achieved a Top-1 of 91.2 and a Top-5 of 99.7. HOME-T2-O3-Self-One achieved a Top-1 of 91.2 and a Top-5 of 99.7. As discussed herein, it was assumed that the cross-mixed-moment is equivalent to the self-mixed-moment as the embedding features of different transformations tend to be the same, which is demonstrated by the results. It was not necessary to impose the empirical constraints on all transformations, since randomly selecting one seemed sufficient to yield the equivalent results, which helps save the computational cost.

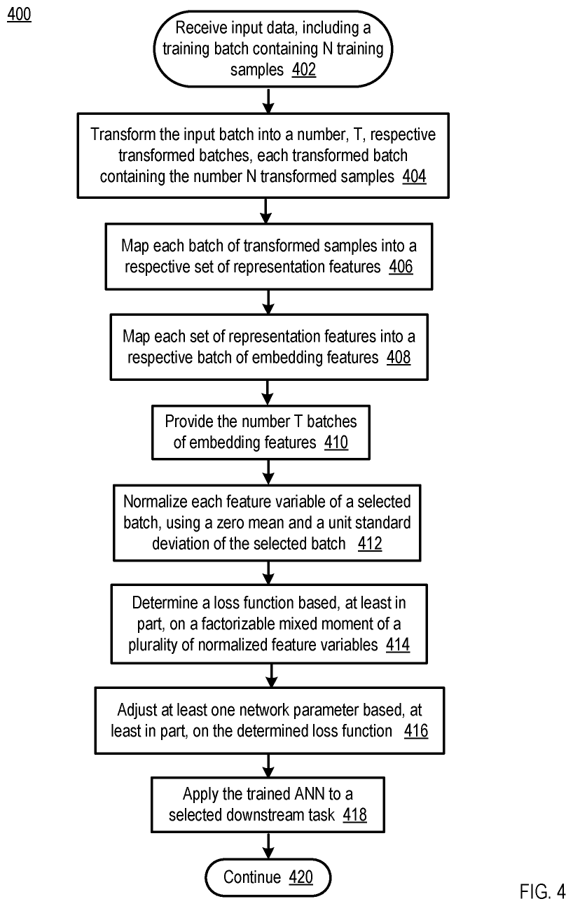

FIG. 4 is a flowchart 400 of operations for self-supervised representation learning, according to various embodiments of the present disclosure. In particular, the flowchart 400 illustrates generating a number of batches of embedding features and training an ANN, in an SSRL framework. The operations may be performed, for example, by the SSRL system 102 (e.g., SSRL circuitry 104) of FIG. 1.

Operations of this embodiment may begin with receiving input data at operation 402. The input data includes a training batch containing a number, N, training samples. Operation 404 includes transforming the training batch into a number, T, respective transformed batches. Each transformed batch is configured to contain the number N transformed samples. Each batch of transformed samples may be mapped into a respective set of representation features at operation 406. Each set of representation features may be mapped into a respective batch of embedding features at operation 408.

Operation 410 includes providing the number, T, batches of embedding features. Each batch includes the number, N, embedding features. Each transformed batch corresponds to a respective transformation of the training batch. The embedding features may be related to the transformed batches. Each embedding feature has a dimension, D. Each embedding feature element corresponds to a respective feature variable. Each feature variable of a selected batch may be normalized using a zero mean and a unit standard deviation of the selected batch at operation 412. A loss function may be determined based, at least in part, on a factorizable mixed moment of a plurality of normalized feature variables at operation 414. The mixed moment may be of order K. K is less than or equal to the embedding feature dimension D. At least one network parameter may be adjusted based, at least in part, on the determined loss function at operation 416. Operation 418 includes applying the trained ANN to a selected downstream task. Program flow may then continue at operation 420.

Thus, a number of batches of embedding features may be generated, and an ANN may be trained, using self-supervised representation learning. An associated loss function may be determined based, at least in part, on a factorizable mixed moment constraint. At least one network parameter may be adjusted based, at least in part, on a determined loss function value.

The HOME loss function defined in Eq. (3) indicates that with incorporation of relatively high-order mixed moment orders, the self-learning results can be improved, while the computational cost may be increased. In one nonlimiting example, three-order of moments were implemented on a relatively small dataset, and the HOME loss was fully computed. It is contemplated that relatively more efficient algorithms may be utilized and/or relatively more powerful computing platforms may be used for self-learning that includes a larger number of moments for optimizing representation learning models on relatively large-scale datasets. Additionally or alternatively, a portion of high-order elements may be randomly selected in each training iteration to fit the limitations of computers.

Generally, this disclosure relates to a High-Order Mixed-Moment-based Embedding (HOME) approach for representation learning. HOME, as a general self-supervised learning framework, configured to reduce the total correlation among most or all feature variables, making the features rich and compact. Without using ad-hoc techniques, a three-order HOME is configured to achieve competitive results on the CIFAR-10 dataset. It may be appreciated that HOME may be effective to learn the generally expected properties of representation features. It is contemplated that HOME may impact the deep learning field after being adapted to refined versions and applied to various tasks in different domains.

As used in any embodiment herein, “network”, “model”, “ANN”, and “neural network” (NN) may be used interchangeably, and all refer to an artificial neural network that has an appropriate network architecture. Network architectures may include one or more layers that may be sparse, dense, linear, convolutional, and/or fully connected. It may be appreciated that deep learning includes training an ANN. Each ANN may include, but is not limited to, a deep NN (DNN), a convolutional neural network (CNN), a deep CNN (DCNN), a multilayer perceptron (MLP), etc. Training generally corresponds to “optimizing” the ANN, according to a defined metric, e.g., minimizing a cost (e.g., loss) function.

As used in any embodiment herein, the terms “logic” and/or “module” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry”, as used in any embodiment herein, may include, for example, singly or in any combination, hardwired circuitry, programmable circuitry such as computer processors comprising one or more individual instruction processing cores, state machine circuitry, and/or firmware that stores instructions executed by programmable circuitry. The logic and/or module may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc.

Memory 142 may include one or more of the following types of memory: semiconductor firmware memory, programmable memory, non-volatile memory, read only memory, electrically programmable memory, random access memory, flash memory, magnetic disk memory, and/or optical disk memory. Either additionally or alternatively system memory may include other and/or later-developed types of computer-readable memory.

Embodiments of the operations described herein may be implemented in a computer-readable storage device having stored thereon instructions that when executed by one or more processors perform the methods. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

1. A self-supervised representation learning (SSRL) circuitry, the SSRL circuitry comprising:
a normalizer circuitry configured to receive a number, T, batches of embedding features, each batch including a number, N, embedding features, the number N corresponding to a number of input samples in a training batch, the number T corresponding to a number of respective transformed batches, each transformed batch corresponding to a respective transformation of the training batch, the embedding features related to the transformed batches, each embedding feature having a dimension, D, and each embedding feature element corresponding to a respective feature variable;
the normalizer circuitry further configured to normalize each feature variable of a selected batch, using a zero mean and a unit standard deviation of the selected batch; and
a loss function circuitry configured to determine a loss function based, at least in part, on a factorizable mixed moment of a plurality of normalized feature variables, the mixed moment of order K, K less than or equal to the embedding feature dimension D.

2. The SSRL circuitry of claim 1, wherein at least one network parameter of an encoder circuitry is adjusted based, at least in part, on the determined loss function, the adjusting configured to reduce a total correlation between a plurality of feature variables.

3. The SSRL circuitry of claim 1, wherein the loss function comprises a transform invariance constraint.

4. The SSRL circuitry of claim 1, wherein the loss function is:
$$L = \frac{1}{D} {\sum }_{d = 1}^{D} \frac{2}{T ( T - 1 )} \text{?} {( 1 - \text{?} )}^{2} + λ \frac{1}{T} \text{?} \frac{1}{M} \text{?} {( \frac{1}{N} \text{?} )}^{2} .$$
$$\text{?} \text{indicates text missing or illegible when filed}$$

5. The SSRL circuitry of claim 1, wherein each feature variable is normalized as:
$$\text{?} = \frac{{z}_{nd}^{t} - \frac{1}{N} {\sum }_{n = 1}^{N} {z}_{nd}^{t}}{\sqrt{{\sum }_{n = 1}^{N} {( {z}_{nd}^{t} - \frac{1}{N} {\sum }_{n = 1}^{N} {z}_{nd}^{t} )}^{2}}} .$$
$$\text{?} \text{indicates text missing or illegible when filed}$$

6. The SSRL circuitry according to claim 1, wherein K is two or three.

7. The SSRL circuitry according to claim 1, wherein each transformation is selected from the group comprising random cropping, horizontal flip, color jittering, grayscale, Gaussian blur, and solarization.

8. A method for self-supervised representation learning (SSRL), the method comprising:
receiving, by a normalizer circuitry, a number, T, batches of embedding features, each batch including a number, N, embedding features, the number N corresponding to a number of input samples in a training batch, the number T corresponding to a number of respective transformed batches, each transformed batch corresponding to a respective transformation of the training batch, the embedding features related to the transformed batches, each embedding feature having a dimension, D, and each embedding feature element corresponding to a respective feature variable;
normalizing, by the normalizer circuitry, each feature variable of a selected batch, using a zero mean and a unit standard deviation of the selected batch; and
determining, by a loss function circuitry, a loss function based, at least in part, on a factorizable mixed moment of a plurality of normalized feature variables, the mixed moment of order K, K less than or equal to the embedding feature dimension D.

9. The method of claim 8, wherein at least one network parameter of an artificial neural network (ANN) is adjusted based, at least in part, on the determined loss function, the adjusting configured to reduce a total correlation between a plurality of feature variables.

10. The method of claim 8, further comprising:
receiving, by a transform circuitry, input data comprising a training batch containing the number, N, training samples;
transforming, by the transform circuitry, the training batch into the number, T, respective transformed batches, each transformed batch containing the number N transformed samples;
mapping, by an encoder circuitry, each batch of transformed samples into a respective set of representation features; and
mapping, by a projector circuitry, each set of representation features into a respective batch of embedding features,
wherein at least one network parameter of the encoder circuitry is adjusted based, at least in part, on the determined loss function.

11. The method of claim 8, wherein the loss function comprises a transform invariance constraint.

12. The method of claim 8, wherein a loss function is:
$$L = \frac{1}{D} {\sum }_{d = 1}^{D} \frac{2}{T ( T - 1 )} \text{?} {( 1 - \text{?} )}^{2} + λ \frac{1}{T} \text{?} \frac{1}{M} \text{?} {( \frac{1}{N} \text{?} )}^{2} .$$
$$\text{?} \text{indicates text missing or illegible when filed}$$

13. The method of claim 8, wherein each feature variable is normalized as:
$${\hat{z}}_{nd}^{t} = \frac{{z}_{nd}^{t} - \frac{1}{N} {\sum }_{n = 1}^{N} {z}_{nd}^{t}}{\sqrt{{\sum }_{n = 1}^{N} {( {z}_{nd}^{t} - \frac{1}{N} {\sum }_{n = 1}^{N} {z}_{nd}^{t} )}^{2}}} .$$

14. A self-supervised representation learning (SSRL) system, the SSRL system comprising:
a transform circuitry configured to receive input data, the input data comprising a training batch containing a number, N, training samples, the transform circuitry configured to transform the training batch into a number, T, respective transformed batches, each transformed batch containing the number N transformed samples;
an artificial neural network (ANN) configured to determine a respective batch of embedding features for each batch of transformed samples; and
an SSRL circuitry comprising:
a normalizer circuitry configured to receive the number, T, batches of embedding features, each batch including the number, N, embedding features, the number T corresponding to a number of respective transformed batches, each transformed batch corresponding to a respective transformation of the training batch, the embedding features related to the transformed batches, each embedding feature having a dimension, D, and each embedding feature element corresponding to a respective feature variable,
the normalizer circuitry further configured to normalize each feature variable of a selected batch, using a zero mean and a unit standard deviation of the selected batch, and
a loss function circuitry configured to determine a loss function based, at least in part, on a factorizable mixed moment of a plurality of normalized feature variables, the mixed moment of order K, K less than or equal to the embedding feature dimension D.

15. The SSRL system of claim 14, wherein at least one network parameter of the ANN is adjusted based, at least in part, on the determined loss function, the adjusting configured to reduce a total correlation between a plurality of feature variables.

16. The SSRL system of claim 14 or 15, wherein the ANN comprises:
an encoder circuitry configured to map each batch of transformed samples into a respective set of representation features; and
a projector circuitry configured to map each set of representation features into a respective batch of embedding features,
wherein at least one network parameter of the encoder circuitry is adjusted based, at least in part, on the determined loss function.

17. The SSRL system of claim 14, wherein the loss function comprises a transform invariance constraint.

18. The SSRL system of claim 14, wherein the loss function is:
$$L = \frac{1}{D} {\sum }_{d = 1}^{D} \frac{2}{T ( T - 1 )} \text{?} {( 1 - \text{?} )}^{2} + λ \frac{1}{T} \text{?} \frac{1}{M} \text{?} {( \frac{1}{N} \text{?} )}^{2} .$$
$$\text{?} \text{indicates text missing or illegible when filed}$$

19. The SSRL system of claim 14, wherein each feature variable is normalized as:
$$\text{?} = \frac{{z}_{nd}^{t} - \frac{1}{N} {\sum }_{n = 1}^{N} {z}_{nd}^{t}}{\sqrt{{\sum }_{n = 1}^{N} {( {z}_{nd}^{t} - \frac{1}{N} {\sum }_{n = 1}^{N} {z}_{nd}^{t} )}^{2}}} .$$
$$\text{?} \text{indicates text missing or illegible when filed}$$

20. A computer readable storage device having stored thereon instructions that when executed by one or more processors result in the following operations comprising: the method according to claim 8.
